(19) United States
(12) Patent Application Publication
(10) Pub. No.: US 2019/0384489 A1
(43) Pub. Date: Dec. 19, 2019

(54) Multiple-Sensory User Interface for Computing

(71) Applicant: Ashwin P Rao, Kirkland, WA (US)

(72) Inventor: Ashwin P Rao, Kirkland, WA (US)

(21) Appl. No.: 16/388,833

(22) Filed: Apr. 18, 2019

Related U.S. Application Data
(60) Provisional application No. 62/659,172, filed on Apr. 18, 2018.

(51) Int. Cl. G06F 3/0488; G06F 3/16; G06F 3/0482

(52) U.S. Cl. CPC G06F 3/04883; G06F 2203/04803; G06F 3/0482; G06F 3/167

(57) ABSTRACT

The disclosure describes a generalized system and method to incorporate speak-n-touch UI and multi-sense UI into applications. Several examples are considered. Additionally, several new user experiences across a variety of applications are also presented. Our approach has potential to shift the interface paradigm and propel a new wave of artificial intelligence based general purpose computing.

### CROSS-REFERENCE TO RELATED APPLICATIONS

This patent application claims priority to U.S. Provisional Patent Application No. 62,659,172 filed Apr. 18, 2018, which is incorporated herein by reference in its entirety.

### FIELD OF THE INVENTION

The invention relates to multiple sensory systems and multi-sense user interfaces (UIs) for human-machine interactions.

### BACKGROUND

User interface (UI) for human-machine interactions has an interesting history. It all began in the 1970s when the graphical UI or GUI was used for interacting with computers. Then in the 1980s, the Mouse and GUI were used for commercializing personal computing. Then in the 1990s, the GUI further evolved and got fully adopted for word processing and other forms of desktop computing. In 2007, marking a somewhat 11-year cycle, Multi-Touch UI changed it all and ushered users into a new era of mobile computing. Today's mobile phones and tablets are comparable to supercomputers of the past. Unfortunately, their bottleneck is the UI. For the simplest of tasks, like formatting words in a document, users need to navigate multiple layers of hidden menus that requires time and practice.

Having users use voice assistants is not an option because they are specially designed to automate information access using hands-free voice only interactions. The voice assistants do not enhance routine work on computers. Conveying instructions to voice assistants is still not ideal. What is needed is a UI that allows completion of complicated instructions with an easy and intuitive design.

### BRIEF DESCRIPTION OF THE DRAWINGS

The foregoing aspects and many of the attendant advantages of this invention will become more readily appreciated as the same become better understood by reference to the following detailed description, when taken in conjunction with the accompanying drawings, wherein:

FIG. 1 is a block diagram that illustrates components of one embodiment of a multiple-sensory user interface (UI) for incorporating speak-n-touch UI into applications;

FIG. 2 is a block diagram that illustrates components of another embodiment of a multiple-sensory UI for incorporating speak-n-touch UI for typing;

FIG. 3 is a block diagram that illustrates components of another embodiment of a multiple-sensory UI for incorporating speak-n-touch UI for text editing/formatting;

FIG. 4 is a block diagram that illustrates components of another embodiment of a multiple-sensory UI for incorporating speak-n-touch UI for photo/image editing;

FIG. 5 is a block diagram that illustrates components of another embodiment of a multiple-sensory UI for incorporating speak-n-touch UI for creating spreadsheets;

FIG. 6 is a chart that illustrates multi-sensory inputs for incorporating speak-n-touch UI into other applications;

FIG. 7 illustrates a keyboard using the present multi-sensory UI;

FIG. 8 is a table that compares the present multi-sensory UI with prior-art;

FIG. 9 is an illustration employing the present multi-sensory UI with a word processor using speak-n-touch UI;

FIG. 10 is a table that compares speak-n-touch word processor with prior-art;

FIG. 11 is an illustration employing the present multi-sensory UI with illustrates photo editing using speak-n-touch UI; and

FIG. 12 is a functional block diagram representing a computing device for use in certain implementations of the disclosed embodiments or other embodiments of the present multiple-sensory UI.

### DETAILED DESCRIPTION OF THE PREFERRED EMBODIMENT

The present multiple-sensory user interface allows completion of complicated instructions using an easy and intuitive design. For example, let's say there are 18 random balls on a screen and you want to make one of them large. Using prior UI, explaining this to the voice assistant using voice only is almost impossible. However, with the present UI, the user may use multiple modes to interact with the assistant. The user can tell the assistant, “make this large”, while simultaneously pointing to or touching the ball.

For several years, the present inventor has proposed inventions around combining multiple sensory inputs to create seamless multi sensory UIs that have been called speak-n-touch UI and multi-sense UI. For the present multiple-sensory UI, a generalized method to use the speak-n-touch UI for building applications and for redesigning some daily-used software is described. The present multiple-sensory UI has the potential to shift the interface paradigm and propel a whole new wave of artificial intelligence based general purpose computing.

Whereas the present multiple-sensory UI addresses the more general problem of building applications using multiple sensory inputs, for ease of explanation, the following discussion describes the multiple-sensor UI using only two inputs, namely speech and touch (referred to as speak-n-touch). Those skilled in the art will appreciate and understand the inclusion of other sensory inputs to further enhance the multiple-sensory UI.

The overall philosophy underlying the present multiple-sensory UI is to make a screen come alive and have it react based upon when, where, and how a user touches it and what the user speaks to it. This is a complete shift in the input paradigm from prior art. The present multiple-sensory UI eliminates the need for a dedicated voice button or the need for users to speak a keyword. Thus, the present multiple-sensory UI makes way for a seamless speak-n-touch experience. The present multiple-sensory UI offers several advantages: 1) increases speech recognition accuracies; 2) creates a semantic context for acoustic search at the location where the screen is touched; and 3) allows filtering out neighboring noise at the time when the screen is touched.

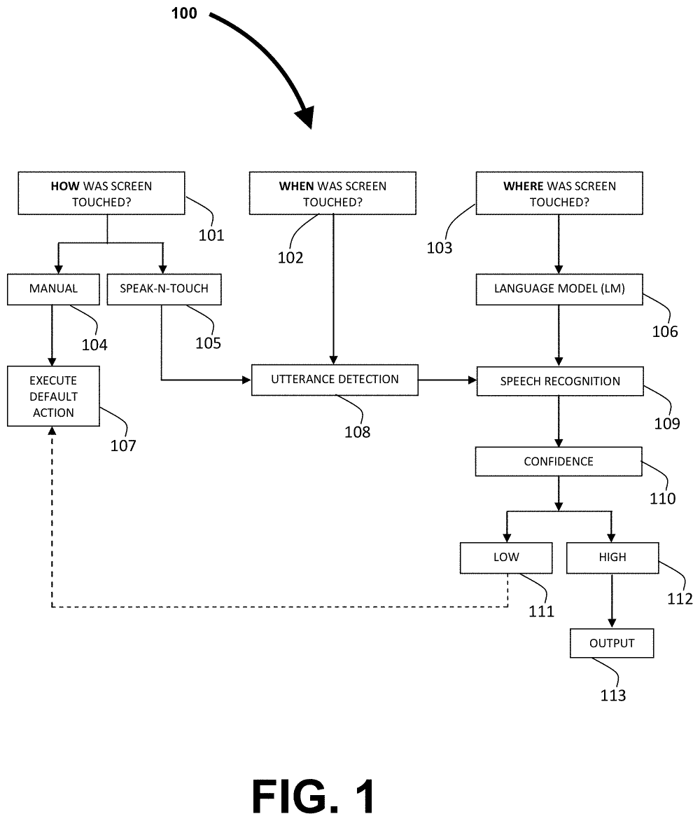

FIG. 1 is a block diagram 100 that illustrates components of one embodiment of a multiple-sensory user interface (UI) for incorporating speak-n-touch UI into applications. For ease of explanation, most blocks in FIG. 1 represents processing performed by a processor in determining actions of a user or responding to actions of the user. The processing may be formed by one module, by multiple modules, or one module may perform processing of several of the illustrated blocks. For convenience, the blocks are referred to as individual modules. However, so describing the processing in this manner does not limit the scope of the recited claims. In this method, module 101 detects how the user touches the screen, module 102 detects when the user touches the screen, and module 103 detects where the user touches the screen. If the user simply touches the screen then module 104 detects this action and carries out the default touch action in module 107. However, if the user speaks a command while touching the screen then module 105 detects this. Using knowledge from module 102 on when the user touched the screen, utterance detection module 108 then performs utterance detection by searching portions of the waveform in the neighborhood of the times when the user touched the screen. The detected utterance is then fed to a speech recognition module 109. Language module 106 uses knowledge of where the user touched the screen received from module 103 to construct a language model (LM) that it feeds to the speech recognizer 109. Speech recognizer 109 outputs the speech recognition result 113 (e.g, output) along with a confidence score 110. If a low confidence is received by module 110, module 111 simply executes the default touch action in module 107. In the event that a high confidence is received, module 112 sends the output from module 113 to an application (NOT SHOWN).

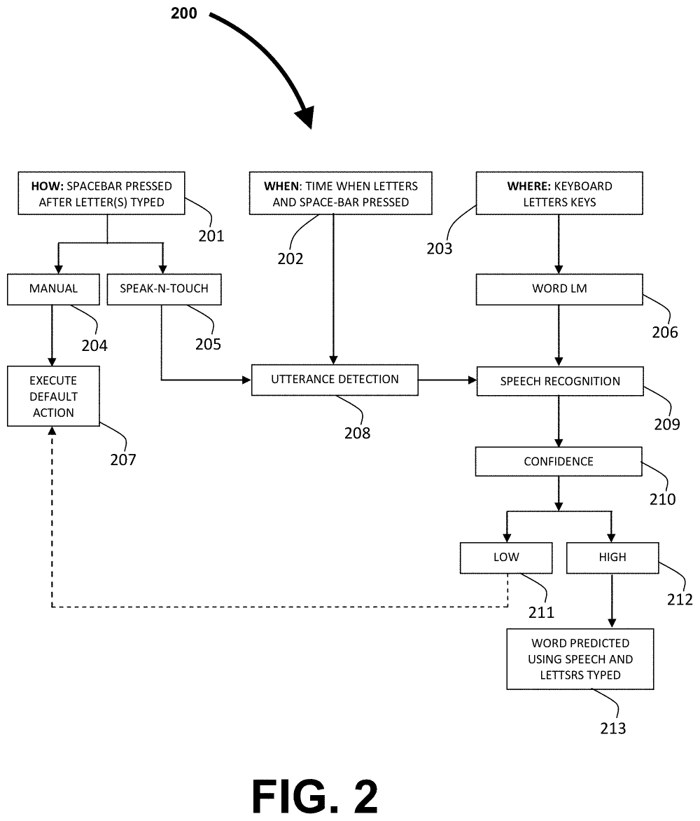

FIG. 2 is a block diagram that illustrates components of another embodiment of a multiple-sensory UI for incorporating speak-n-touch UI for typing. FIG. 2 extends the method in FIG. 1 to typing. Specifically, when a user speaks a word while typing its letters (as shown in 201) and then presses the spacebar, module 205 detects that the user spoke while typing and makes a call to the utterance detection module 208. Using knowledge of the times when the user typed the letters and hit the space bar, as obtained from module 202, module 208 does utterance detection and sends the detected utterance to the speech recognizer 209. Using knowledge that the user touched the keyboard's letter keys (obtained from module 203), module 206 constructs a Word LM corresponding to a set of likely words that the letters could correspond; ambiguity in the letters pressed is also accounted for in this process. The Word LM is then sent by module 206 to the speech recognizer 209. The speech recognizer 209 recognizes the utterance detected in module 208 using the word LM received from module 206 and outputs the result in module 213 along with a confidence score from module 210. If a low confidence is received, then module 211 simply executes the default touch action in module 207. In the event that a high confidence is received, module 212 sends the output in module 213 to the application.

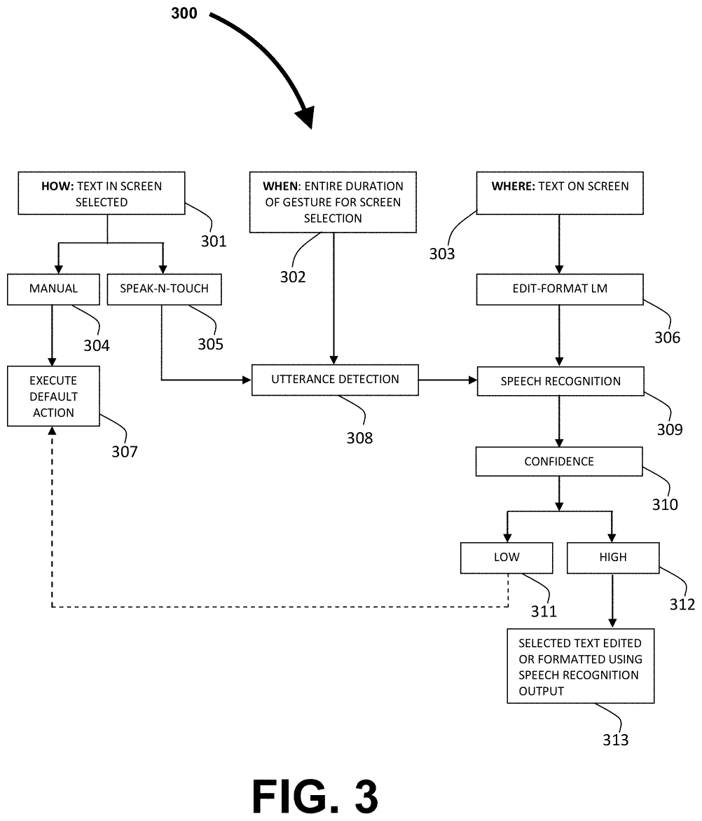

FIG. 3 is a block diagram that illustrates components of another embodiment of a multiple-sensory UI for incorporating speak-n-touch UI for text editing/formatting. FIG. 3 extends the method in FIG. 1 to word processing. Specifically, when a user speaks a command while selecting text in screen (as shown in module 301) and then releases the user's finger, module 305 detects that the user spoke while selecting text and makes a call to the utterance detection module, 308. Using knowledge of the times when the user selected text on screen obtained from module 302, module 308 does utterance detection and sends the resulting utterance to the speech recognizer module 309. Using knowledge that the user touched the text on the screen as obtained from module 303, module 306 constructs an LM corresponding to a set of likely commands that the word processor allows for text editing and formatting. This Edit-Format LM is then sent by module 306 to the recognizer module 309. The recognizer module 309 recognizes the utterance from module 308 using the Edit-Format LM of module 306 and outputs the result in module 313 along with a confidence score in module 310. If a low confidence is received, then module 311 simply executes the default touch action in module 307. In the event that a high confidence is received, module 312 sends the output in module 313 to the application.

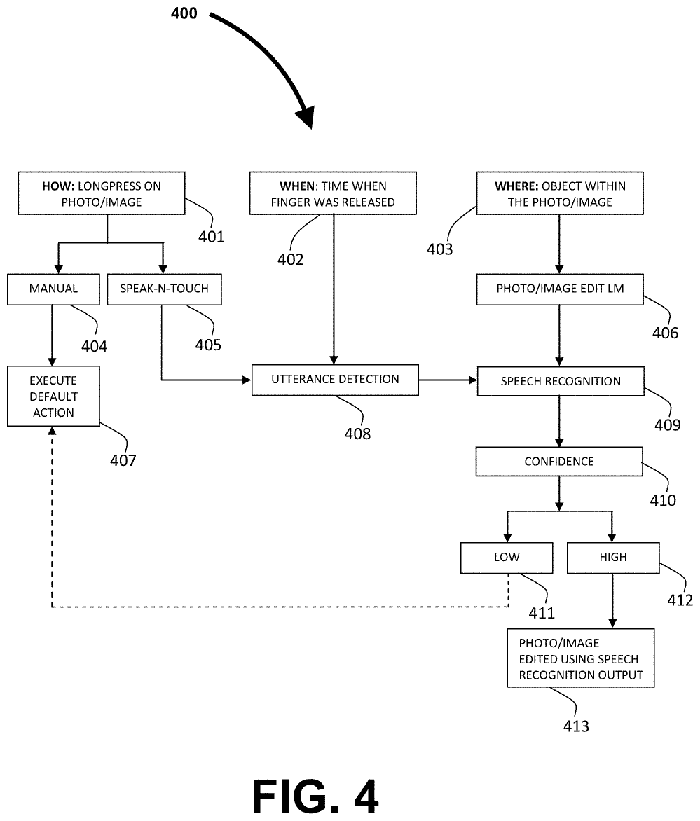

FIG. 4 is a block diagram that illustrates components of another embodiment of a multiple-sensory UI for incorporating speak-n-touch UI for photo/image editing. FIG. 4 extends the method in FIG. 1 to photo/image editing. Specifically, when a user speaks a command while long-pressing any part of a photo/image (as detected in module 401 and represented by module 401) and then releases finger, module 405 detects that the user spoke while editing photo/image and calls the utterance detection module of 408. Using knowledge of the times when the user long-pressed the photo/image, obtained from module 402, module 408 does utterance detection and sends the resulting utterance to the speech recognizer module 409. In parallel, the module 403 detects the specific object the user touched within the photo/image and sends that information to module 406. Using this knowledge module 406 constructs an LM corresponding to a set of likely commands that the photo/image editor application allows for editing photos/images. This Photo-Image-Edit LM is then sent by module 406 to the recognizer module 409. The recognizer module 409 recognizes the utterance in module 408 using the LM of module 406 and outputs the result from module 413 along with a confidence score in module 410. If a low confidence is received, then module 411 simply executes the default touch action in module 407. In the event that a high confidence is received, module 412 sends the output in module 413 to the application.

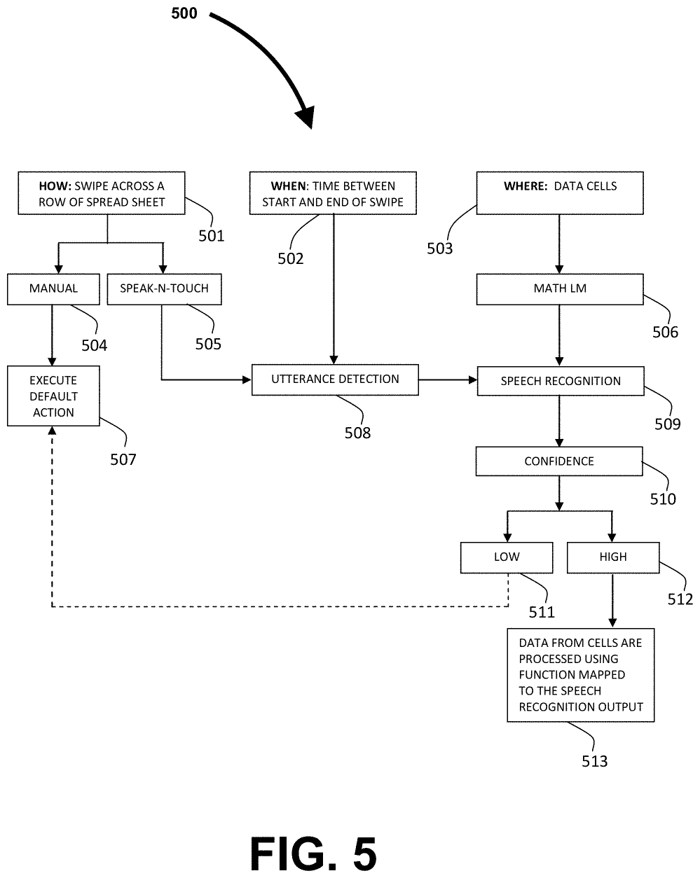

FIG. 5 is a block diagram that illustrates components of another embodiment of a multiple-sensory UI for incorporating speak-n-touch UI for creating spreadsheets. FIG. 5 extends the method in FIG. 1 to the creation of spreadsheets. Specifically, when a user speaks a command while swiping across cells in a row of a spread sheet (as detected in module 500 and represented as module 50) and then releases the user's finger, module 505 detects that the user spoke while swiping across the cells and calls the utterance detection module of 508. Using knowledge of the times between the start and end of user's swiping, obtained from module 502, module 508 does utterance detection and sends the resulting utterance to the speech recognizer module 509. In parallel, module 503 detects the user has swiped across some data cells within a row of the spreadsheet and sends that information to module 506. Using this knowledge, module 506 constructs an LM corresponding to a set of likely Math commands that could operate on the kind of data selected by the user. This Math LM is then sent by module 506 to the speech recognizer module 509. The speech recognizer module 509 recognizes the utterance in module 508 using the LM of module 506 and outputs the result from module 513 along with a confidence score in module 510. If a low confidence is received, then module 511 simply executes the default touch action in module 507. In the event that a high confidence is received, module 512 sends the output in module 513 to the application.

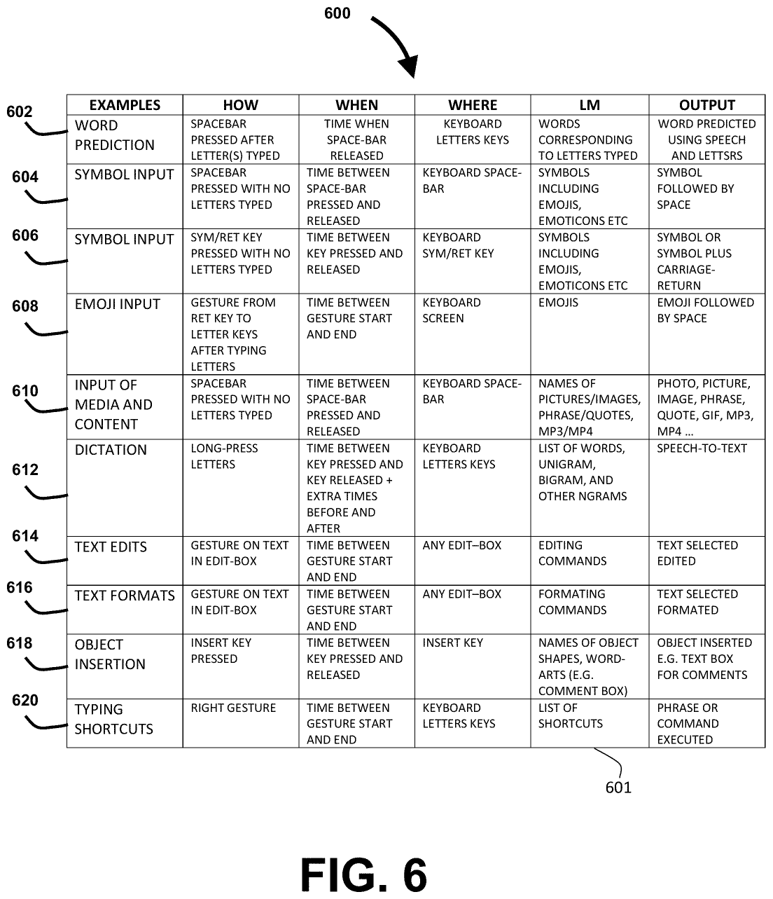

FIG. 6 is a chart that illustrates multi-sensory inputs for incorporating speak-n-touch UI into other applications. Specifically, FIG. 6 lists several use-cases for using speak-n-touch UI for everyday computing. These include word prediction while typing (ROW 602), symbol input while typing (ROWS 604 and 606), emoji input while messaging (ROW 608), input of media and content into applications (ROW 610), speech-to-text on the fly (ROW 612), text editing/formatting (ROWS 614 and 616), insertion of objects in graphic editors (ROW 618), and short cuts for typing or command execution (ROW 620). Whereas most of the use-cases in 601 are self explanatory, ROW 620 is further explained in more detail below.

In several keyboards or word processors, there is a function called “short cut” that lets users create short cuts for frequently used phrases. For instance a user may create a short cut called “MyAddress” for an address like “100 University St., Apt 12255, Seattle, Wash., 98011”. Once created, the user then simply types the shortcut, namely MyAddress, and the keyboard or word processor displays an option to select the address mapped to the MyAddress short-cut. The problem here is the user has to remember the short-cut and type it out to use it. In accordance with the present multi-sensory UI using speak-n-touch UI, the user may simply speak the short cut (or some word that closely resembles that short cut) while swiping right on the keyboard's letter keys to input the phrase mapped to that short-cut. Thus, the burden to remember the shortcut is relaxed and the number of letters required to type the short cut is reduced to zero.

Those skilled in the art will appreciate that several variants of the examples mentioned ROW 620 may be employed to address a myriad of computing applications across several platforms, languages, and devices. We next describe some applications that have been redesigned to incorporate the present speak-n-touch UI.

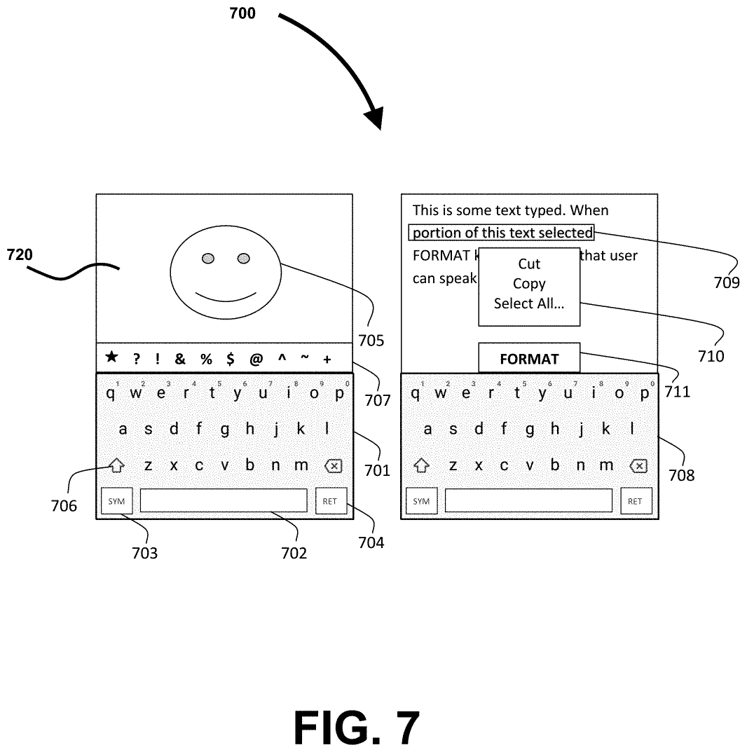

FIG. 7 illustrates a device 700 incorporating the present multi-sensory UI, specifically the speak-n-touch UI. Device 700 includes a keyboard 701 and incorporates the present speak-n-touch UI. Device 700 provides at least the following advantages: 1) faster and easier typing; 2) faster and easier input of symbols, emoticons, emojis, gifs, and stickers; 3) new ways of expressing using sketches, quotes, and MP3s; and 4) faster editing and formatting.

Prior-art keyboards based on touch inputs typically required users to switch between multiple screens (or type letters and then hunt-and-peck prediction choices) to type words along with symbols, emoticons, emojis, gifs, and stickers. The addition of screens added complexity to the prior art UI. Additionally, the need to switch screens (or hunt-and-peck choices) slows down the overall typing speed drastically and also disrupts the flow in typing in prior art keyboards. Also, in prior art keyboards, to use speech-to-text or dictation input, users needed to press a voice-button (or say a trigger word), wait (sometimes for a beep), and then speak a sentence. Many a times, especially when speaking in noisy environments, the user needed to press the voice-key again to go back to typing. If the system made no mistakes, then this 4-step process was better than just typing. But when errors occurred, this 4-step process resulted in a very slow UI for typing.

The proposed multiple sensory UI addresses the above problems by 1) implementing speak-n-touch UI directly on the space-bar for input of symbols, emoticons, gifs, and stickers; and 2) implementing speak-n-touch UI directly on qwerty keys for on-the-fly dictation so that users can speak sentences while touching anywhere on the qwerty screen.

An example of typing a sentence, “Saturday/Sunday? It's going to be sunny and 70° Two-hearts-emoji Convertible or Motorcycle”, using keyboard 701 is now described: user types the word Saturday using the letter keys associated with keyboard 701, then holds SYM key 703, and says slash, then types the word Sunday, using the letter keys associated with keyboard 701, then holds spacebar 702, and says question. Subsequently, while holding any letter key associated with keyboard 701, user says it's going to be sunny and 70 and then the user holds the spacebar 702 and says degrees. Finally, the user once again holds the spacebar 702 and says two hearts emoji and subsequently presses any letter key associated with keyboard 701 and dictates Convertible or Motorcycle. Observe that since these actions do not require the user to change modes per se, it makes it very easy to mix speaking and typing, to do error corrections, and to input different types of symbols, emoticons, emojis, stickers, and gifs.

Those skilled in the art will appreciate that the extra-large spacebar 702 in keyboard 701 is possible because by using the present speak-n-touch UI, several keys in prior-art keyboards may be eliminated, such as an emoji key, a settings key, a speech-to-text key and the like. Those skilled in the art will also appreciate that several variants of the present UI being proposed may be considered. For example, speak-n-touch the “D” letter key of 701 to dictate; speak-n-touch the spacebar 702 to dictate sentences also but have the system automatically detect whether the user is dictating a phrase or inputting symbols; instead of saying emoji each time swipe from the RET key 704; tap the shift key 706 before swiping from RET key 704 to input a sticker instead of an emoji. Those skilled in the art will also appreciate that since emojis, stickers, gifs, and the like, are directly inputted into the application using the proposed invention, an option can be displayed to a user who may tap the option to see a whole list of emojis/stickers/gifs. Now, referring back to the example described above for FIG. 7, screen 720 illustrates the inputting of a happy sticker 705. In this example, if the user taps the * (i.e. 707) in the choice window, the keyboard displays different types of happy stickers for the user to select.

Those skilled in the art will further appreciate that speech recognition language modeling (LM) techniques may be used to exploit the user behavior of mixing typing and dictation. For instance, text typed before and/or after dictation may be used as context to speech-to-text input. Conversely, text prediction LMs can use speech recognizer outputs to build better text prediction LMs. The LM itself may range from simple n-grams to topic LMs. Additionally, since majority of users are expected to use this for messaging, a specialized “Chat LM” can be built for better accuracy.

Using the power of speak-n-touch UI and its ability to bring several layers of hidden features at the very top, FIG. 7 also shows ways to input new forms of expressions to enrich the overall typing experience. For instance, instead of the user saying happy sticker and the keyboard 701 displaying the happy sticker 705, the user could say happy sketch or happy line or happy MP3 and the keyboard could display a sketch, a quote, or an MP3 sound clip respectively, associated with the happy expression. Several categories may be supported like happy, heart, thank you, good luck, party and the like. More importantly, the stickers may be input in one-step by simply speaking and touching the space-bar. The following provides some examples: 1) say “heart line” while touching the spacebar 702 for a line from “heart” category, 2) say “party line” while touching the spacebar 702 for a line from “party” category, 3) say “heart sketch” while touching the spacebar 702 for a sketch of “heart” category, and 4) more generally say <category> followed by <type> while touching the spacebar 702 to input a specific type of expression from a specific category.

Those skilled in the art will recognize that several extensions to the above input of expressions are possible. For instance, each time a user invokes a category, a new expression may be dynamically generated, with an option to choose previously used ones by simply pressing * displayed in the choice window 707. Additionally, on top of the displayed expression, several choices can be displayed (e.g. most-popular, never-used, latest, social-feeds, AI recommended etc). Additionally the user could have an option to tap to save the current expression as “use-this-for-future” in which case it gets displayed alongside any new ones generated. Additionally, once an expression is displayed, the user has a further option to press “+” displayed in choice window 707 to add text to expressions, e.g. heart sketch displays a sketch for heart category and + adds text to that sketch.

Finally, the databases underlying sketches, lines, mp3s, and other additions, could be built in-house or could be crowd sourced so as to enable artists and musicians to have a new channel to showcase their creations. Those skilled in the art will appreciate that these new expressions can also be used across a variety of other applications that support the specific file formats.

Using the power of speak-n-touch UI and its ability to bring several layers of hidden features at the very top, FIG. 7 also shows ways to include full-featured formatting within the keyboard itself without the need for any extra keys. For instance, FIG. 7 shows that when a user selects text 709 on screen, instead of the prior-art formatting menu 710 that consists of only three formatting options, a “format” key 711 pops up that the user can speak-n-touch to do any and all kinds of text formatting. So basically, users can now format text in any application directly via the keyboard; and create emails, messages, status updates etc that are much more interesting compared to boring old text. For instance, user could say “bold large underline” (or underline bold large with no restrictions on order) and have the selected text made bold, large, and underlined all at once. As another example, user could say “small emphasize” to make the text smaller in size and emphasized.

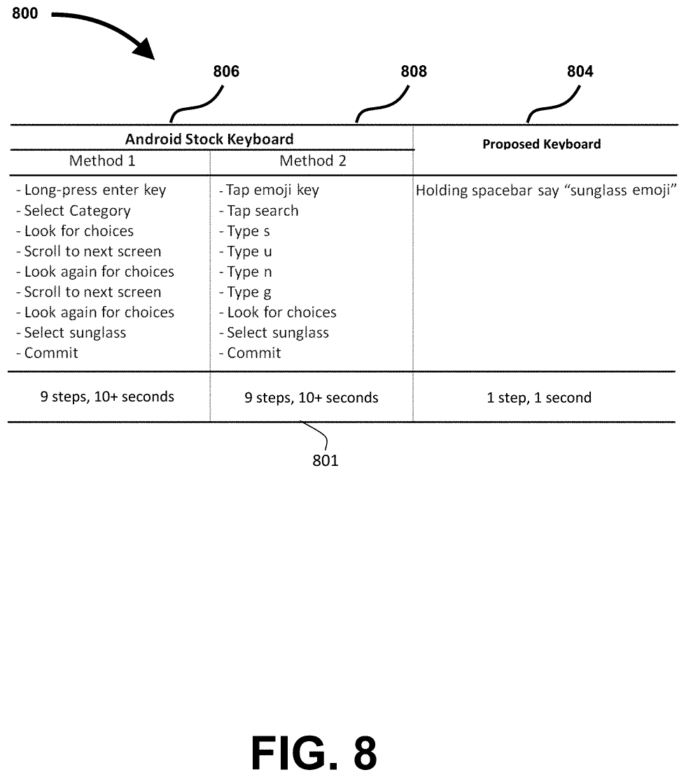

FIG. 8 is a table that compares the present multi-sensory UI with prior-art UI. In FIG. 8, an example of entering an emoji for sunglass is considered that clearly demonstrates that the proposed keyboard dramatically increases the speed and ease of inputting emojis while typing words. The proposed keyboard actions 804 can be compared with prior art actions 806 and 808 to clearly see the ease of use and speed for using the present multi-sensory UI.

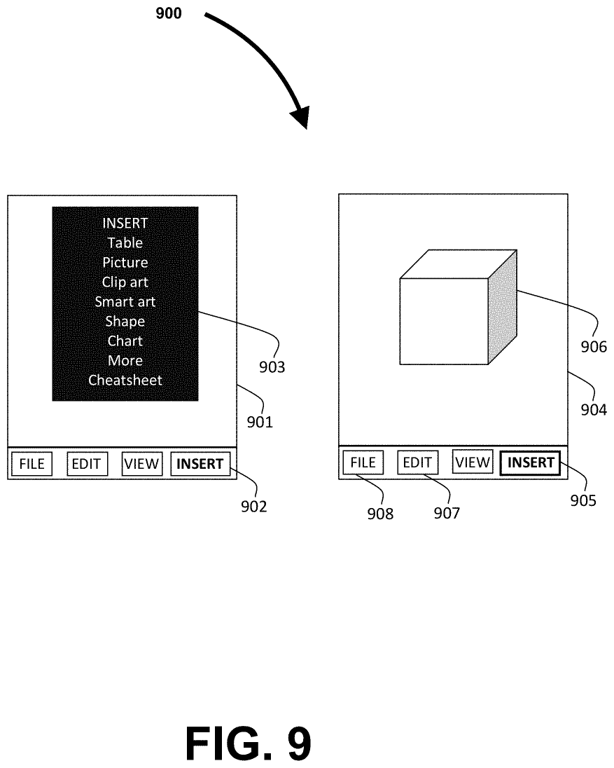

FIG. 9 is an illustration employing the present multi-sensory UI with a word processor using speak-n-touch UI. The word processor incorporates the present speak-n-touch UI to allow faster and easier text editing and formatting; faster and easier insertion of objects within body of text; and the ability to add new word processing features and functionalities. This is described next after a brief background on the current state of word processing.

Document creation on mobile devices has been a dream for almost a decade now. Unfortunately no solution has been able to make this dream a reality. Typically, users migrate to laptops and other desktop computers to do any kind of heavy duty word processing. Even there, the need for navigating traditional GUI based File-Menu structures make the overall experience very cumbersome. Additionally, currently available word processing apps inherit steep user learning curves associated with familiarization of buttons, functionalities, and app features, and to become a master user of these apps, one needs to remember the hierarchy of options within the apps' layouts. All of this gets even more complicated every time a new version of word processor with changes in UI is released.

As shown in FIG. 9, a word processor 901 incorporating the present speak-n-touch UI solves these problems by enabling users to accomplish tasks using one simple and straightforward speak and touch action. Even the words that users would require to speak have been selected wisely to make the overall usage very intuitive. For instance, to color some text yellow, the user needs to say “color yellow”, something that users are already familiar with from their use of drop-down menus of current work applications. Other examples include (a) while selecting text using a swipe gesture saying “color magenta”, (b) while selecting text using two fingers (or multi-touch) say “bullet list”, (c) while selecting a number on screen say “average” to compute average of all numbers in a row consisting of the touched number, (d) while selecting a range of numbers on screen say “variance”, (e) while selecting an already formatted text say “find repeat” to similarly format all occurrences of similar text, and (f) while swiping through saying “magenta bold large” to make the entire text bold, large, and of color magenta.

Apart from editing and formatting, the proposed word processor makes it extremely easy to insert objects into the document. For instance, in FIG. 9, using word processor 904, a user could simply speak-and-touch the Insert key 905 to insert a cube 906. Other examples may include (a) while holding the Insert key 905 say “rectangle”, (b) while holding the Edit key 907 say “Insert rectangle”, (c) while holding the Edit key 907 say “Fill yellow”, (d) while holding the File key 908 say “share on social media” and so on.

Finally, one will notice that the proposed word processor 901 provides an option to not use speak-n-touch UI but simply back off to using touch UI. For instance to insert an object, the user may choose not to speak while holding the Insert key 902 but to simply tap it to get a menu of insert options 903 for manual selection.

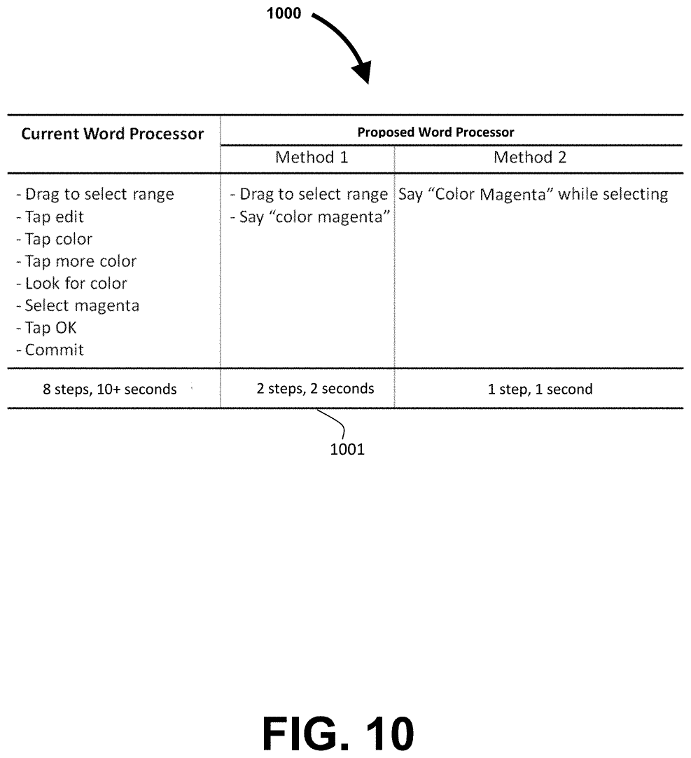

FIG. 10 is a table that compares speak-n-touch word processor with prior-art word processors. One may observe that the proposed word processor incorporating speak-n-touch UI is significantly faster, easier, and more intuitive. The word processor incorporating the multi-sensory UI leap-frogs all current methods of document creation on screens.

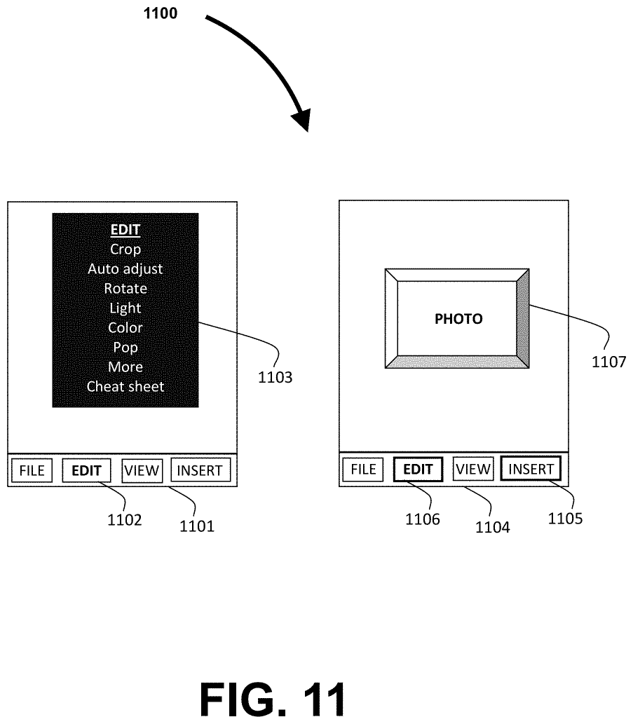

FIG. 11 is an illustration employing the present multi-sensory UI with photo editing using speak-n-touch UI. A photo editor incorporates the present speak-n-touch UI thereby allowing one-step editing of photos; faster and easier insertion of objects within a photo; and adding new photo editing features and functionalities.

As shown in FIG. 11, using photo editor 1104, a user can simply hold the Insert key 1105 and say “recent photo” or “last used” to insert the specific photo. The user could also say stored file names like “MyTromsoWalk” or can say an approximate file name as in “NorwayDecember2017”. In the former case, the proposed photo editor easily locates the file and in the later case the photo editor predicts the file name using location and the date and displays choices. In another variation, the user could simply say “whatsapp” or “camera” and the app will bring up all photos from those folder(s). These and other variations are envisioned and are too numerous to include examples of each.

Once a specific photo is inserted and is ready for editing, the user can hold the Edit key 1106 and say any editing command like rotate fifteen, flip left, flip right, bright, dark and the like. The invention also proposes that several options be displayed to the user for finer controls. For example, for the bright option, several levels of brightness adjustment controls may be displayed. Furthermore, the photo editor 1104 includes some very cool new features to make the overall photo editing experience very enjoyable, including a command called “Flip Join” that simply flips the photo being edited and joins it (accounting for appropriate cropping) with the original to create a new flip-joined photo; and commands like “spot light”, “color mix” and so on.

Just like the word processor of FIG. 9, in the proposed photo editor 1101, the user can simply tap the keys without long-pressing them to back-off to touch-only UI or to learn speak-n-touch commands. For instance, as shown in FIG. 11 if the user taps the edit key 1102 then the word processor 1101 displays options 1103 for the Edit key along with a choice called cheat-sheet which when touched displays a list of possible editing functions the user could tap or use as speech commands. Those skilled in the art will appreciate that several variants of what's proposed may be added to essentially reinvent photo editing on screens.

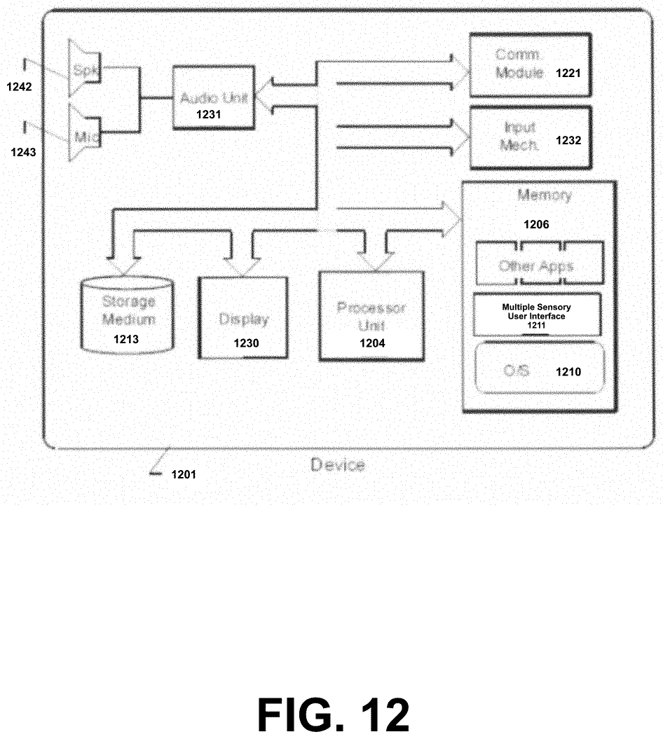

FIG. 12 is a functional block diagram representing a computing device for use in certain implementations of the disclosed embodiments or other embodiments of the present multiple-sensory UI. FIG. 12 is a functional block diagram representing a computing device for use in certain implementations of the disclosed embodiments or other embodiments of the method for multiple-sensory UI. The mobile device 1201 may be any handheld computing device and not just a cellular phone. For instance, the mobile device 1201 could also be a mobile messaging device, a personal digital assistant, a portable music player, a global positioning satellite (GPS) device, or the like.

In this example, the mobile device 1201 includes a processor unit 1204, a memory 1206, a storage medium 1213, an audio unit 1231, an input mechanism 1232, and a display 1230. The processor unit 1204 advantageously includes a microprocessor or a special purpose processor such as a digital signal processor (DSP), but may in the alternative be any conventional form of processor, controller, microcontroller, state machine, or the like.

The processor unit 1204 is coupled to the memory 1206, which is advantageously implemented as RAM memory holding software instructions that are executed by the processor unit 1204. In this embodiment, the software instructions stored in the memory 1206 include a multiple sensory user interface method 1211, a runtime environment or operating system 1210, and one or more other applications 1212. The memory 1206 may be on-board RAM, or the processor unit 1204 and the memory 1206 could collectively reside in an ASIC. In an alternate embodiment, the memory 1206 could be composed of firmware or flash memory. The memory 1206 may store the computer-readable instructions associated with the multiple sensory user interface method 1211 to perform the actions as described in the present application.

The storage medium 1213 may be implemented as any nonvolatile memory, such as ROM memory, flash memory, or a magnetic disk drive, just to name a few. The storage medium 1213 could also be implemented as a combination of those or other technologies, such as a magnetic disk drive with cache (RAM) memory, or the like. In this particular embodiment, the storage medium 1213 is used to store data during periods when the mobile device 1201 is powered off or without power. The storage medium 1213 could be used to store contact information, images, call announcements such as ringtones, and the like.

The mobile device 1201 also includes a communications module 1221 that enables bi-directional communication between the mobile device 1201 and one or more other computing devices. The communications module 1221 may include components to enable RF or other wireless communications, such as a cellular telephone network, Bluetooth connection, wireless local area network, or perhaps a wireless wide area network. Alternatively, the communications module 1221 may include components to enable land line or hard wired network communications, such as an Ethernet connection, RJ-11 connection, universal serial bus connection, IEEE 1394 (Firewire) connection, or the like. These are intended as non-exhaustive lists and many other alternatives are possible.

The audio unit 1231 is a component of the mobile device 1201 that is configured to convert signals between analog and digital format. The audio unit 1231 is used by the mobile device 1201 to output sound using a speaker 1242 and to receive input signals from a microphone 1243. The speaker 1232 could also be used to announce incoming calls.

A display 1230 is used to output data or information in a graphical form. The 1230 display could be any form of display technology, such as LCD, LED, OLED, or the like. The input mechanism 1232 may be any input mechanism. Alternatively, the input mechanism 1232 could be incorporated with the display 1230, such as the case with a touch-sensitive display device. The input mechanism 1232 may also support other input modes, such as lip tracking, eye tracking, thought tracking as described above in the present application. Other alternatives too numerous to mention are also possible.

The UI methodologies proposed in this invention may also be used to re-build applications like presentations, spreadsheets, and painting/drawing etc. For example speak-n-touch commands for presentation may include: say “table” while touching a location, say “connect” or “arrow” while swiping from one text-box to another text-box, say “title” while selecting text, say “line graph” while selecting numbers etc. Examples of speak-n-touch commands for spreadsheets may include: say “average” while touching a cell that titles an entire column, say “average” while swiping through a row of numbers, select a column of numbers and say “average” while touching a cell where you need the result to be entered, say “compound interest 5 years” while touching a number, say “aggregate” while double-tapping several columns. Several variations like entering the results of calculations directly in a new cell that makes it meaningful are also possible. For example, saying “median” while touching a table-cell that titles an entire column results in the median being entered in a new cell that's at the bottom of the column along with a suitable title text-cell to show this. Examples of speak-n-touch commands for graphics include: while touching an object on screen say delete/large/color blue/color red/three times large/two times large/send to back/rotate fifteen/rotate minus thirty; while touching multiple objects say color brown; while touching the + key say smiling sun/rings/clouds etc; while touching a location on screen say move here; while touching the edit key say insert ellipse/insert rings/background dots/background stars; while swiping on screen say light blue brush/red pencil/pink water brush.

Those skilled in the art will recognize that more generally a software development kit (SDK) may be built around the proposed invention to enable third party developers to use the proposed invention to rethink and re-imagine a myriad of products and services: 1) building gaming apps: imaging saying “lightning” while touching a time and location on screen to create an effect of lightning at that specific time and place, 2) using music editing apps: imagine saying “repeat” while selecting a segment of audio while editing music, 3) using video apps: imagine saying “actor name” while touching or pointing to a character on your youtube screen, 4) using augmented reality (AR) Systems: imagine saying “grab this, this, and this” (while pointing to three objects in your AR field) and then saying “export here”

Finally, the proposed method to incorporate speak-n-Touch UI may be easily extended to the more generalized scenario of using multi-sense UI. The following examples will illustrate this:

1. A virtual voice assistant (of the likes of Siri, Alexa, Google etc) that's detecting utterance using a user's eye tracking features;

2. A TV remote using lips, eyes, and speech for seamless interaction;

3. Holographic videos wherein users can interact with characters and objects in an un-tethered way by simply speaking, pointing, and looking; and thus have a fully-immersive cinematic experience.

The present multiple sensory UI also proposes several other possible enhancements as listed below:

1. Having the UI structured in a way that the user can easily back-off to single mode interactions;

2. Choosing words from drop-down tree menu as voice speech commands, so users need not learn new ones and can easily look up if needed;

3. Choosing small words for faster interactions e.g. zoom70 for zooming view by 70%;

4. Setting commands using several permutations of words e.g. color yellow or yellow or yellow color;

5. Setting multiple actions in one command e.g. bold-large-underline, small-emphasize;

6. Using natural language processing to enable unrestricted usage of words e.g. make this yellow, turn this yellow and the like;

7. Using touch-pressure applied by the user in conjunction with speech e.g. if a user says color yellow while swiping on screen but varies the pressure of touch while swiping, then the system uses pressure profile to generate different shades of yellow;

8. Using users volume of speech (or other prosodic features like pitch and duration) in conjunction with speech e.g. if a user says color yellow while swiping on screen but varies his/her speaking volume while swiping, then the system uses speech volume profile to generate different shades of yellow;

9. Incorporating new commands like remove dash, replace space by dash etc. that otherwise are hard to incorporate in drop-down menus due to constraints in menu size;

10. Building a hardware version of a keyboard along with a track pad, that can do editing, formatting, and expressions using speak-n-touch UI;

11. Building error checks in the UI for example if the user touches a letter on screen but says average then system ignores average and looks for next best recognition choice that's not a number;

12. Implementing speak-n-touch UI on a dedicated button which may be used for global commands in applications like search, excel, charts, email composition and the like; and

13. Input of symbol/emoji along with a comma/period by tracing an arc starting at sym/ret key, continuing over letter keys, and ending onto the left/right end of the spacebar.

Those skilled in the art will appreciate that these examples serve as reference templates for re-thinking and re-imagining a myriad of applications including audio, video, music, maps, gaming, AR, VR, little apps like airline ticketing and movie reservations that incorporate the present multiple sensory UI.

The claimed invention is:

1. A system incorporating a multiple sensory user interface, comprising:
a module for detecting touches on a screen;
a module for determining a time for when touches occurred on the screen;
a module for detecting speech being associated with the touch; and
a module for outputting a result based on the touch, the time and the speech.

2. A method for incorporating a multiple sensory user interface, comprising:
computer-readable instructions for detecting touches on a screen;
computer-readable instructions for determining a time for when touches occurred on the screen;
computer-readable instructions for detecting speech being associated with the touch; and
computer-readable instructions for outputting a result based on the touch, the time, and the speech.
